(19) United States
(12) Patent Application Publication
(10) Pub. No.: US 2023/0015659 A1
(43) Pub. Date: Jan. 19, 2023

(54) VEHICLE BODY REAR STRUCTURE

(71) Applicant: HONDA MOTOR CO., LTD., Tokyo (JP)

(72) Inventors: Takuya Sasaki, Tokyo (JP); Toshihiro Yamaguchi, Tokyo (JP); Kyosuke Yamakita, Tokyo (JP); Takashi Nitta, Tokyo (JP); Dai Kamata, Tokyo (JP); Yusuke Miura, Tokyo (JP)

(21) Appl. No.: 17/863,429

(22) Filed: Jul. 13, 2022

(30) Foreign Application Priority Data
Jul. 15, 2021 (JP) 2021-117083

(51) Int. Cl. B62D 43/10; B62D 25/08; B62D 43/00

(52) U.S. Cl. CPC B62D 43/10; B62D 25/08; B62D 43/005

(57) ABSTRACT

This vehicle body rear structure includes a tire pan provided to protrude downward from a floor of a vehicle rear section and including a spare tire fixing portion configured to fix a center portion of a spare tire, and a jack base provided on the tire pan, and the jack base extends downward from the tire pan on a rear side with respect to a vehicle body, and has a front end portion continuously extending from the spare tire fixing portion to a front side of the vehicle body.

### CROSS-REFERENCE TO RELATED APPLICATION

The present application claims priority based on Japanese Patent Application No. 2021-117083, filed Jul. 15, 2021, the content of which is incorporated herein by reference.

### BACKGROUND OF THE INVENTION

### Field of the Invention

The present invention relates to a vehicle body rear structure.

### Description of Related Art

Regarding a vehicle body rear structure, it is known that a spare tire is accommodated in a spare tire housing (hereinafter, referred to as a tire pan) in an inclined state in which a rear side is lifted upward, and a hook reinforcement member is provided on a bottom surface of the tire pan to extend in a vehicle body forward/rearward direction. The hook reinforcement member is divided into a reinforcement member front portion and a reinforcement member rear portion at a dividing position in the vehicle body forward/rearward direction.

According to the vehicle body rear structure, when a load is input from a side behind the vehicle body, the dividing position of the hook reinforcement member is lifted upward by the input load and the hook reinforcement member is folded in a chevron shape. The tire pan is also folded in a chevron shape as the hook reinforcement member is folded in a chevron shape. Accordingly, a rear side of the spare tire is lifted further upward by the hook reinforcement member and the tire pan that are folded in a chevron shape. Accordingly, forward and upward movement of the spare tire is suppressed, and thus, the spare tire can be prevented from coming into contact with a rear seat to apply a load (for example, see Japanese Unexamined Patent Application, First Publication No. 2011-131712).

### SUMMARY OF THE INVENTION

However, in the vehicle body rear structure disclosed in Japanese Unexamined Patent Application, First Publication No. 2011-131712, the spare tire is accommodated in the tire pan in an inclined state in which a rear side thereof is lifted upward. Accordingly, the rear side of the spare tire protrudes to a cargo compartment to reduce a space of the cargo compartment. For this reason, it may be difficult to secure sufficient space in the cargo compartment.

An aspect of the present invention is directed to providing a vehicle body rear structure capable of preventing a spare tire from applying a load to a rear seat when a load is input from a side behind a vehicle body, and further, allowing sufficient space to be secured in a cargo compartment.

In order to accomplish the above-mentioned purposes, a vehicle body rear structure according to an aspect of the present invention employs the following configurations.

(1) An aspect of the present invention is a vehicle body rear structure (for example, a vehicle body rear structure (10) of an embodiment) including a tire pan (for example, a tire pan (15) of the embodiment) provided to protrude downward from a floor of a vehicle rear section (for example, a rear floor (14) of the embodiment) and including a spare tire fixing portion (for example, a spare tire fixing portion (34) of the embodiment) configured to fix a center portion of a spare tire (for example, a spare tire (41) of the embodiment); and a jack base (for example, a jack base (20) of the embodiment) provided on the tire pan, and the jack base extends downward from the tire pan on a rear side with respect to a vehicle body, and has a front end portion (for example, a front end portion (20a) of the embodiment) continuously extending from the spare tire fixing portion to a front side of the vehicle body.

According to the aspect of the above-mentioned (1), the jack base extends downward from the tire pan on the rear side with respect to the vehicle body, and the front end portion of the jack base continuously extends from the spare tire fixing portion to the front side of the vehicle body.

Here, for example, it is assumed that, upon a rear end collision from behind the vehicle body, the load is input to the rear wall portion (a rear end portion) of the jack base (specifically, a base portion) and the front end portion of the base portion is rotated upward. Accordingly, the spare tire fixing portion of the tire pan can be lifted upward and toward a rear side of the vehicle body by the front end portion of the jack base that is rotating. Accordingly, the front portion of the spare tire can be flipped up and toward the rear side of the vehicle body. Accordingly, the front portion of the spare tire can be prevented from coming into contact with a rear seat. Accordingly, it is possible to prevent the spare tire from applying the load input from behind the vehicle body to the rear seat. Further, for example, it is also possible to prevent a load from being applied to a battery or the like provided below the vehicle body.

In addition, when the front portion of the spare tire is flipped up and toward the rear side of the vehicle body by the front end portion of the jack base that is rotating, the spare tire can be accommodated horizontally in the tire pan. Accordingly, it is possible to secure sufficient space in a cargo compartment formed above the tire pan.

(2) In the aspect of the above-mentioned (1), the jack base may include a base portion (for example, a base portion (61) of the embodiment) extending downward from the tire pan on a rear side of the vehicle body; and a forward extension portion (for example, a forward extension portion (62) of the embodiment) continuously extending from a front end portion (for example, a front end portion (61b) of the embodiment) of the base portion to a side further forward in the vehicle body from the spare tire fixing portion.

According to the aspect of the above-mentioned (2), the jack base includes the base portion and the forward extension portion. In addition, the base portion extends downward from the tire pan on the rear side with respect to the vehicle body, and the forward extension portion continuously extends from the front end portion of the base portion to a side further forward in the vehicle body than the spare tire fixing portion. Accordingly, when a load is input to the rear wall portion (rear end portion) of the base portion, the front end portion of the base portion is rotated upward, and the forward extension portion is rotated upward together with the base portion.

Accordingly, the spare tire fixing portion of the tire pan can be lifted upward and toward the rear side of the vehicle body by the forward extension portion that is rotating. Accordingly, the area in front of the spare tire can be flipped up and toward the rear side of the vehicle body.

In addition, the jack base is constituted by the base portion and the forward extension portion. Accordingly, for example, when the forward extension portion continuously extends along the tire pan, a relatively large compartment (space) can be secured below the forward extension portion (i.e., the tire pan). Accordingly, the room below the tire pan can be effectively utilized, and for example, a degree of freedom in layout when components of the vehicle body are disposed can be increased.

(3) In the aspect of the above-mentioned (1), the jack base may include a base portion (for example, a base portion (61) of the embodiment) extending downward from the tire pan on a rear side of the vehicle body; and a forward extension portion (for example, a forward extension portion (62) of the embodiment) continuously extending along the tire pan from a front end portion (for example, a front end portion (61b) of the embodiment) of the base portion to a side further forward in the vehicle body from the spare tire fixing portion, the base portion may be formed in a convex shape extending downward from a rear end portion of the tire pan, and the forward extension portion may extend parallel to a bottom surface (for example, a tire pan bottom portion (33) of the embodiment) of the tire pan from an upper front side corner portion (for example, an upper front side corner portion (77) of the embodiment) of the base portion.

According to the aspect of the above-mentioned (3), the base portion extends in a convex shape protruding downward from the rear end portion of the tire pan (the rear side of the vehicle body), and the forward extension portion extends parallel to the bottom surface of the tire pan from the upper front side corner portion of the base portion. Accordingly, when a load is input to the rear wall portion (rear end portion) of the base portion, the upper front side corner portion of the base portion is rotated upward, and the forward extension portion is rotated upward together with the base portion.

Accordingly, the spare tire fixing portion of the tire pan can be lifted upward and toward the rear side of the vehicle body by the forward extension portion that is rotating. Accordingly, the area in front of the spare tire can be flipped up and toward the rear side of the vehicle body.

In addition, when the forward extension portion extends parallel to the bottom surface of the tire pan from the upper front side corner portion of the base portion, a relatively large compartment (space) can be secured below the forward extension portion (i.e., the tire pan). Accordingly, the room below the tire pan can be effectively utilized, and for example, a degree of layout freedom when components of the vehicle body are disposed can be increased.

(4) In the aspect of the above-mentioned (1), the tire pan may have a pan front wall portion (for example, a pan front wall portion (32) of the embodiment) extending upward from a front end portion (for example, a front end portion (33a) of the embodiment) of a bottom surface (for example, a tire pan bottom portion (33) of the embodiment) of the tire pan, and a reinforcement structure (for example, a reinforcement structure (37) of the embodiment) that improves rigidity may be provided on the pan front wall portion.

According to the aspect of the above-mentioned (4), the pan front wall portion of the tire pan extends upward from the front end portion of the bottom surface, and rigidity of the pan front wall portion is improved by the reinforcement structure. Accordingly, for example, when the area in front of the spare tire comes into contact with the pan front wall portion of the tire pan due to a load input from behind the vehicle body, the area in front of the spare tire can be easily flipped upward along the pan front wall portion of the tire pan.

(5) In the aspect of the above-mentioned (4), the reinforcement structure may have a bead shape extending in a shape inclined upward from a lower end portion toward an upper end portion of the pan front wall portion and toward a front side of the vehicle body.

According to the aspect of the above-mentioned (5), the reinforcement structure has a bead shape. Accordingly, rigidity of the pan front wall portion can be efficiently improved without providing a separate member such as a patch member or the like on the pan front wall portion.

In addition, the bead shape of the reinforcement structure extends in a shape inclined upward and toward a front side of the vehicle body from the lower end portion toward the upper end portion of the pan front wall portion. Accordingly, for example, when the area in front of the spare tire comes into contact with the pan front wall portion of the tire pan due to the load input from behind the vehicle body, the area in front of the spare tire can be easily flipped up efficiently along the inclined bead shape.

(6) In the aspect of the above-mentioned (1), the jack base may include a base portion (for example, a base portion (61) of the embodiment) extending downward from the tire pan on a rear side of the vehicle body; and a forward extension portion (for example, a forward extension portion (62) of the embodiment) continuously extending along the tire pan from a front end portion (for example, a front end portion (61b) of the embodiment) of the base portion to a side further forward in the vehicle body from the spare tire fixing portion, and the base portion may be formed in a triangular shape protruding downward when seen in a side view, and the base portion may have a front wall portion (for example, a front wall portion (65) of the embodiment) inclined with a gradient rising upward from a lower end portion toward a front side of the vehicle body.

Here, for example, when the tire pan is shallow (i.e., when the bottom portion of the tire pan is higher than the ground), the base portion of the jack base needs to extend by a large amount downward. For this reason, for example, it is conceivable that, when a load is applied to the base portion by a rear end collision, the base portion be easily folded toward the front side of the vehicle body.

Here, according to the aspect of the above-mentioned (6), the base portion is formed in a triangular shape protruding downward. Further, the front wall portion of the base portion is inclined with a gradient rising toward a front side of the vehicle body as it goes upward from the lower end portion. Accordingly, for example, when the load is applied to the base portion due to the rear end collision, the front wall portion can prevent the base portion from being folded toward a front side of the vehicle body.

Accordingly, the forward extension portion (i.e., the jack base) can be rotated together with the base portion by the load applied to the base portion, and the load applied to the base portion can be transmitted to the tire pan. Accordingly, the spare tire fixing portion of the tire pan can be lifted upward and toward the side behind the vehicle body, and the area in front of the spare tire can be flipped up and toward the side behind the vehicle body.

(7) In the aspect of the above-mentioned (6), the front end portion of the base portion may be connected to a cross member (for example, a cross member (17) of the embodiment) which is provided on the tire pan.

According to the aspect of the above-mentioned (7), the front end portion of the base portion is connected to the cross member. The cross member is a rigid member provided on the tire pan and having high strength and rigidity that bridges skeleton members (for example, rear frames) on left and right sides of the vehicle body. Accordingly, by connecting the front end portion of the base portion to the cross member, the load input from behind the vehicle body can be transmitted to the cross member from the base portion. Accordingly, the base portion can be reliably rotated by the load with no damage to the base portion due to the load.

(8) The aspect of the above-mentioned (1) may include a striker fixing portion (for example, a striker fixing portion (18) of the embodiment) configured to fix a striker (for example, a striker (56) of the embodiment) that holds an opening/closing body configured to open and close a cargo compartment (for example, a cargo compartment (28) of the embodiment) formed above the floor at a closed position; and a reinforcement member (for example, a reinforcement member (19) of the embodiment) configured to reinforce the striker fixing portion, and the jack base may have a rear wall portion (for example, a rear wall portion (66) of the embodiment) connected to the reinforcement member.

According to the aspect of the above-mentioned (8), the rear wall portion of the jack base is connected to the reinforcement member configured to reinforce the striker fixing portion. Accordingly, the rear wall portion of the jack base is reinforced by the reinforcement member of the striker fixing portion, and thus, strength and rigidity of the rear wall portion of the jack base can be increased. Accordingly, the base portion can be reliably rotated by the load which prevents damage to the base portion due to a load input from behind the vehicle body.

(9) In the aspect of the above-mentioned (1), the jack base may include a base portion (for example, a base portion (61) of the embodiment) extending downward from the tire pan on a rear side of the vehicle body; and a forward extension portion (for example, a forward extension portion (62) of the embodiment) continuously extending along the tire pan from a front end portion (for example, a front end portion (61b) of the embodiment) of the base portion to a side further forward in the vehicle body from the spare tire fixing portion, the jack base may further have a first bead (for example, a first bead (75) of the embodiment) provided on a front wall portion (for example, a front wall portion (65) of the embodiment) of the base portion; and a second bead (for example, a second bead (88) of the embodiment) provided on a bottom portion (for example, an extension bottom portion (81) of the embodiment) of the forward extension portion continuous with the front wall portion, and the first bead and the second bead may extend to be continuous in a vehicle body forward/rearward direction.

According to the aspect of the above-mentioned (9), the first bead is provided on the front wall portion of the base portion, and the second bead is provided on the bottom portion of the forward extension portion. Further, the first bead and the second bead extend to be continuous in the vehicle body forward/rearward direction. Accordingly, the load input from behind the vehicle body can be transmitted to the forward extension portion from the base portion. Accordingly, it is possible to prevent the connecting portion between the base portion and the forward extension portion from being folded. Accordingly, the base portion and the forward extension portion can be reliably rotated.

According to the aspect of the present invention, when a load is input from a rear side of the vehicle body, it is possible to prevent the spare tire from applying the load to the rear seat, and further, sufficiently secure the space of the cargo compartment.

### BRIEF DESCRIPTION OF THE DRAWINGS

FIG. 1 is a cross-sectional view showing a vehicle body rear structure of an embodiment according to the present invention.

FIG. 2 is a bottom view showing the vehicle body rear structure of the embodiment.

FIG. 3 is a perspective view showing a state in which the vehicle body rear structure of the embodiment is cut away along a cutting line in a vehicle body forward/rearward direction.

FIG. 4 is a perspective view of the vehicle body rear structure of the embodiment when seen from below and a right side.

FIG. 5 is a perspective view of the vehicle body rear structure of the embodiment when seen from a rear left side of the vehicle body.

FIG. 6 is a side view of the vehicle body rear structure of the embodiment when seen from a left side.

FIG. 7 is a perspective view of a jack base provided on the vehicle body rear structure of the embodiment when seen from below and a left side.

FIG. 8 is a cross-sectional view for describing an example in which an area in front of the spare tire provided in the vehicle body rear structure of the embodiment is flipped up.

FIG. 9 is a cross-sectional view for describing an example in which the area in front of the spare tire provided in the vehicle body rear structure of the embodiment is prevented from applying a load to a rear seat.

### DESCRIPTION OF EMBODIMENTS

Hereinafter, a vehicle body rear structure of an embodiment of the present invention will be described with reference to the accompanying drawings. Further, in the drawings, an arrow FR indicates a forward direction in a vehicle, an arrow UP indicates an upward direction in the vehicle, and an arrow LH indicates a leftward direction of the vehicle.

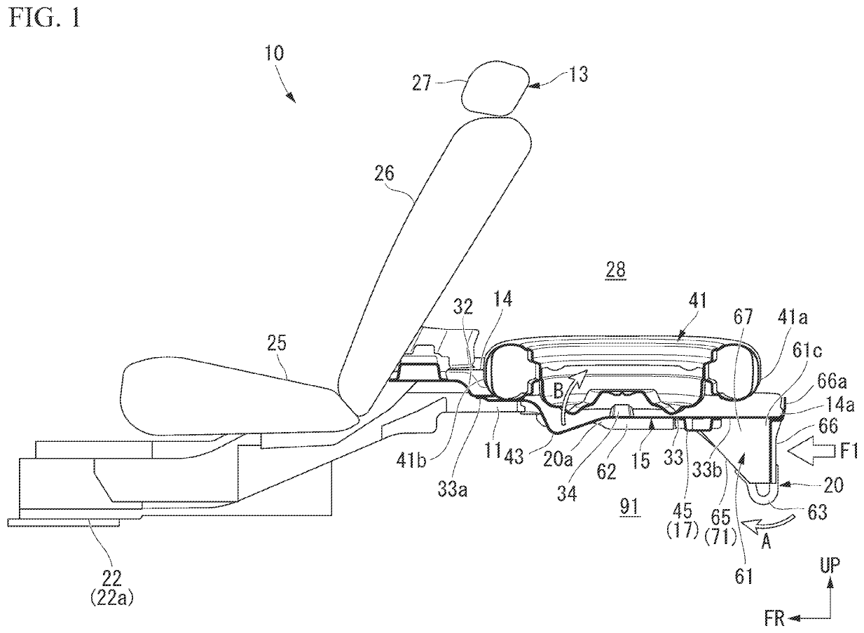

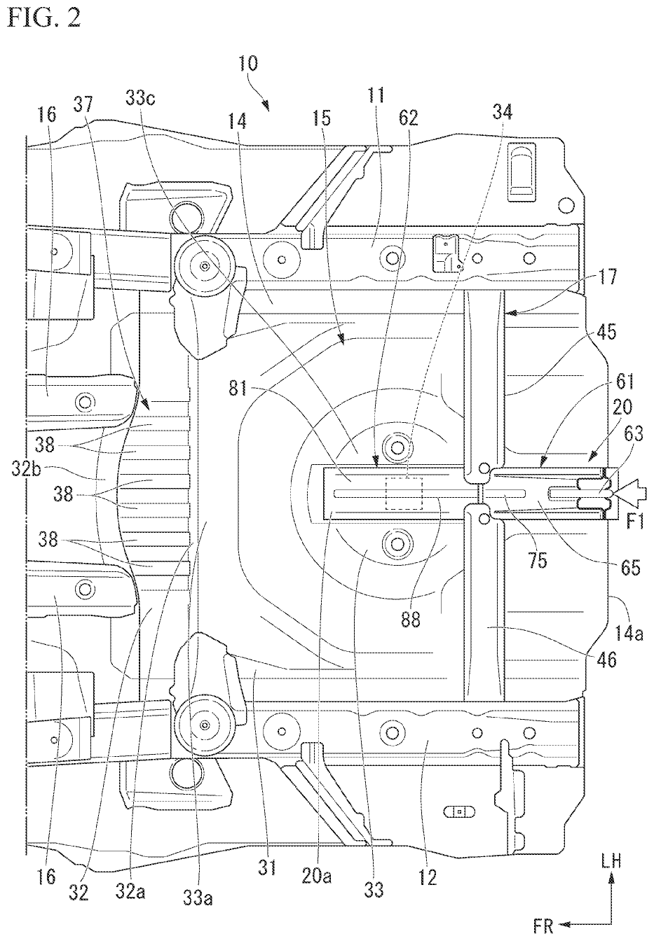

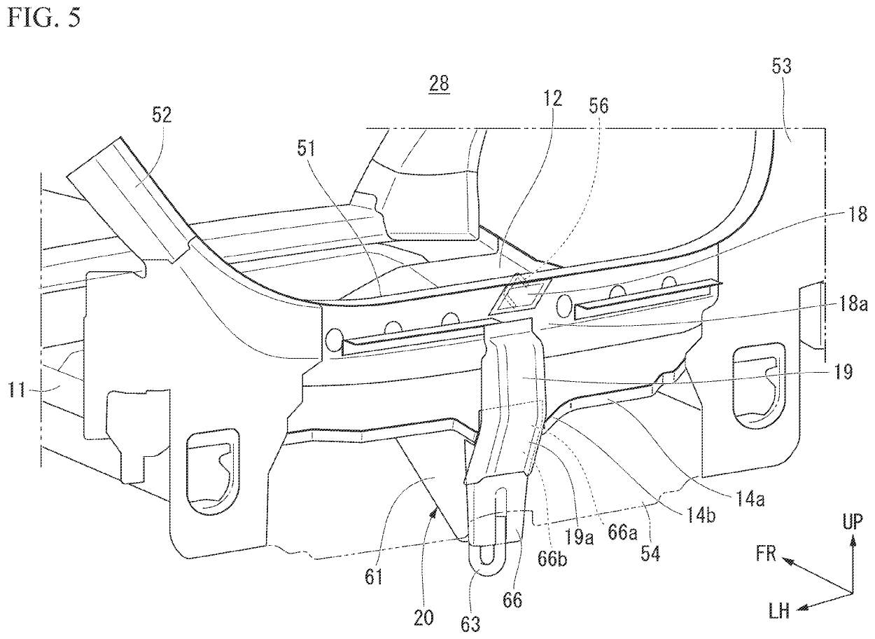

As shown in FIGS. 1 and 2, a vehicle body rear structure 10 includes a left rear frame 11 and a right rear frame 12, a rear seat 13, a rear floor (floor of a vehicle rear section) 14, a tire pan 15, a pair of floor frames 16, a cross member 17, a striker fixing portion 18 (see FIG. 5), a reinforcement member 19 (see FIG. 5), and a jack base 20.

The left rear frame 11 and the right rear frame 12 are provided on left and right outer sides of a lower section of a vehicle body rear section in a vehicle width direction. The left rear frame 11 and the right rear frame 12 are skeleton members with high rigidity that constitute a part of a vehicle body skeleton by being formed with, for example, a hollow closed cross section.

The left rear frame 11 extends toward a side behind the vehicle body from a rear end portion 22a of a left side sill 22. The right rear frame 12 extends toward a side behind the vehicle body from a rear end portion of a right side sill (not shown). The left side sill 22 and the right side sill are skeleton members with high rigidity that constitute a part of the vehicle body skeleton by being formed with, for example, a hollow closed cross section.

For example, the rear seat 13 is provided between the left side sill 22 and the right side sill. The rear seat 13 includes a seat cushion 25, a seatback 26, and a headrest 27.

The seat cushion 25 is a seat provided between the left side sill 22 and the right side sill and on which an occupant sits. The seatback 26 is a backrest portion standing upward from a rear section of the seat cushion 25 and configured to support the back of the occupant who is sitting on the seat cushion 25. The headrest 27 is a headrest portion provided on an upper portion of the seatback 26 and configured support the head of the occupant who is sitting on the seat cushion 25.

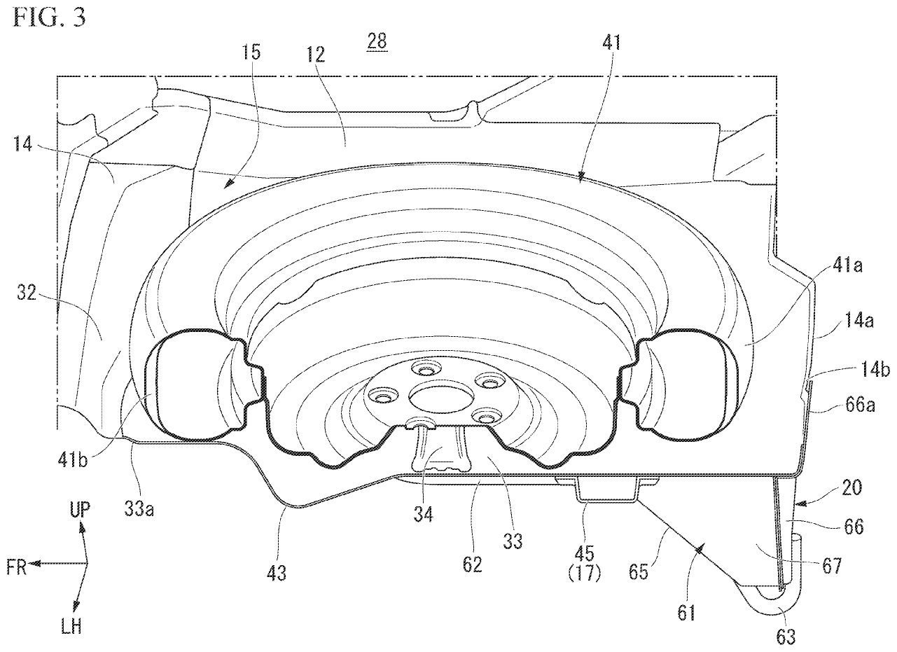

As shown in FIGS. 2 and 3, the rear floor 14 is provided between the left rear frame 11 and the right rear frame 12 and forms a floor portion of a cargo compartment 28.

The tire pan 15 bulges to protrude downward from the rear floor 14. The tire pan 15 has a tire pan sidewall 31, a tire pan bottom portion (bottom surface) 33, and a spare tire fixing portion 34. The tire pan sidewall 31 is folded downward from the tire pan 15. The tire pan sidewall 31 has a pan front wall portion (front surface portion) 32.

The pan front wall portion 32 extends to be inclined upward from a front end portion 33a of the tire pan bottom portion 33 toward a front side of the vehicle body. The pan front wall portion 32 has a reinforcement structure 37. The reinforcement structure 37 is formed with, for example, a plurality of bead portions 38. The bead portions 38 are formed in, for example, a bead shape that bulges forward and downward from the vehicle body.

The plurality of bead portions 38 are disposed at intervals in the vehicle width direction, and extend to be inclined upward from a lower end portion 32a of the pan front wall portion 32 toward an upper end portion 32b and toward a front side of the vehicle body. By providing the reinforcement structure 37 on the pan front wall portion 32, strength and rigidity of the pan front wall portion 32 are improved.

In addition, by setting the reinforcement structure 37 to a bead shape, rigidity of the pan front wall portion 32 can be efficiently improved without providing a separate member such as a patch member or the like on the pan front wall portion 32.

The tire pan bottom portion 33 is provided on a lower end portion of the tire pan sidewall 31. That is, the tire pan bottom portion 33 is provided on a lower section of the tire pan 15. The tire pan bottom portion 33 is formed horizontally, for example. A spare tire 41 is disposed on the tire pan bottom portion 33. Accordingly, the spare tire 41 is accommodated horizontally in the tire pan 15.

The spare tire fixing portion 34 is provided on a center portion of the tire pan bottom portion 33. The spare tire fixing portion 34 protrudes upward from a center portion of the tire pan bottom portion 33. When a fixing tool (not shown) is attached to the spare tire fixing portion 34, the center portion of the spare tire 41 is fixed to the tire pan bottom portion 33 by the spare tire fixing portion 34 and the fixing tool. In this state, the spare tire 41 is accommodated in the tire pan 15 while being disposed horizontally.

Further, a pantograph jack accommodating portion 43 is formed in the tire pan bottom portion 33 in the vehicle body forward/rearward direction of the spare tire fixing portion 34.

The pair of floor frames 16 extends from the pan front wall portion 32 toward a front side of the vehicle body. The pair of floor frames 16 are disposed between the left rear frame 11 and the right rear frame 12 at an interval in the vehicle width direction. The pair of floor frames 16 are provided along the rear floor 14. The pair of floor frames 16 are members having high rigidity formed with, for example, a hollow closed cross section together with the rear floor 14. The pan front wall portion 32 is reinforced by the pair of floor frames 16, and strength and rigidity of the pan front wall portion 32 is more highly secured.

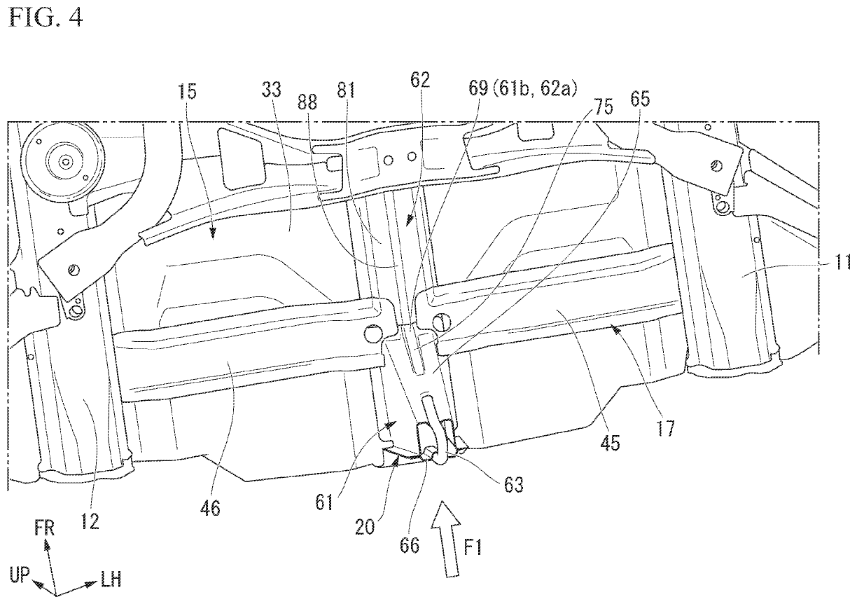

As shown in FIGS. 2 and 4, the cross member 17 is provided on a lower section of the tire pan 15 (specifically, an outer surface of the tire pan 15). The cross member 17 is provided behind the spare tire fixing portion 34 on a rear side of the vehicle body and extends in the vehicle width direction. The cross member 17 is bifurcated into, for example, a left cross member 45 and a right cross member 46.

The left cross member 45 extends along an outer surface of the tire pan 15 on a left side in the vehicle width direction from the jack base 20 to the left rear frame (skeleton member) 11, which will be described below. The left cross member 45 is a member having high rigidity formed with a hollow closed cross section together with the tire pan 15.

The right cross member 46 extends along the outer surface of the tire pan 15 on the right side in the vehicle width direction from the jack base 20 to the right rear frame (skeleton member) 12, which will be described below. The right cross member 46 is a member having high rigidity formed with a hollow closed cross section together with the tire pan 15.

That is, the cross member 17 is a rigid member having high strength and rigidity bridged between the left rear frame 11 and the right rear frame 12 that forms a skeleton member on left and right sides of the vehicle body.

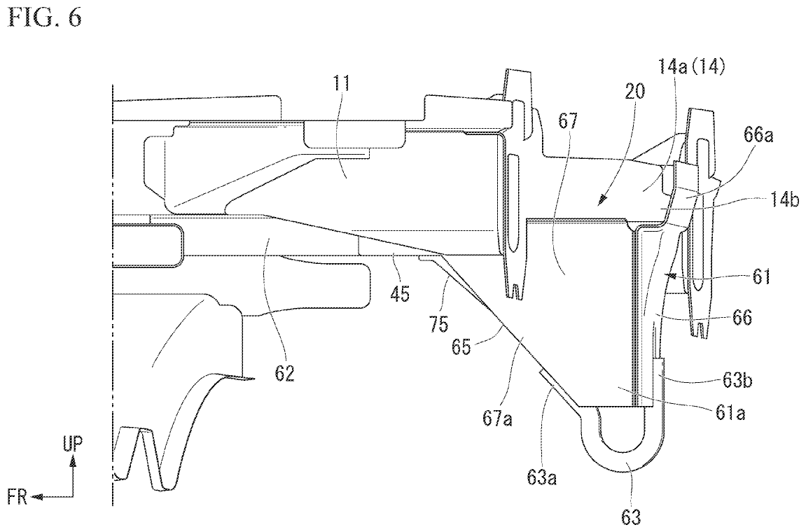

As shown in FIGS. 5 and 6, a rear beam 51 is disposed above a rear end portion 14a of the rear floor 14 with an interval. The rear beam 51 bridges between, for example, a rear end portion of a left rear pillar 52 and a rear end portion of a right rear pillar 53. The rear beam 51 is a member having high rigidity formed with, for example, a hollow closed cross section together with a rear panel 54.

The rear panel 54 is disposed on the rear beam 51 and the jack base 20 (to be described below) on a rear side of the vehicle body and forms a rear wall portion of the cargo compartment 28.

The striker fixing portion 18 is fixed to a center of the rear beam 51 in the vehicle width direction. A striker 56 is fixed to the striker fixing portion 18. A lock mechanism of an opening/closing body (not shown) is locked to the striker 56. The opening/closing body is, for example, a rear lid, a tail gate, or the like, that opens and closes the cargo compartment 28 formed above the rear floor 14.

The lock mechanism of the opening/closing body is locked to the striker 56, and the opening/closing body is held at a closed position. Accordingly, the cargo compartment 28 is closed by the opening/closing body.

The striker fixing portion 18 is reinforced by the reinforcement member 19. The reinforcement member 19 is provided in a lower area 18a of the striker fixing portion 18 in the rear beam 51. The reinforcement member 19 extends downward from the striker fixing portion 18 to a rear wall portion 66 (to be described below) of the jack base 20 and is connected to the rear wall portion 66.

As shown in FIGS. 1 and 2, the jack base 20 is provided on the lower section of the tire pan 15 (specifically, the outer surface of the tire pan bottom portion 33 and the rear end portion 14a of the rear floor 14). The jack base 20 extends downward from the lower section of the tire pan 15 on the rear side with respect to the vehicle body (specifically, the tire pan bottom portion 33), and a front end portion 20a continuously extends to a side further forward in the vehicle body from the spare tire fixing portion 34.

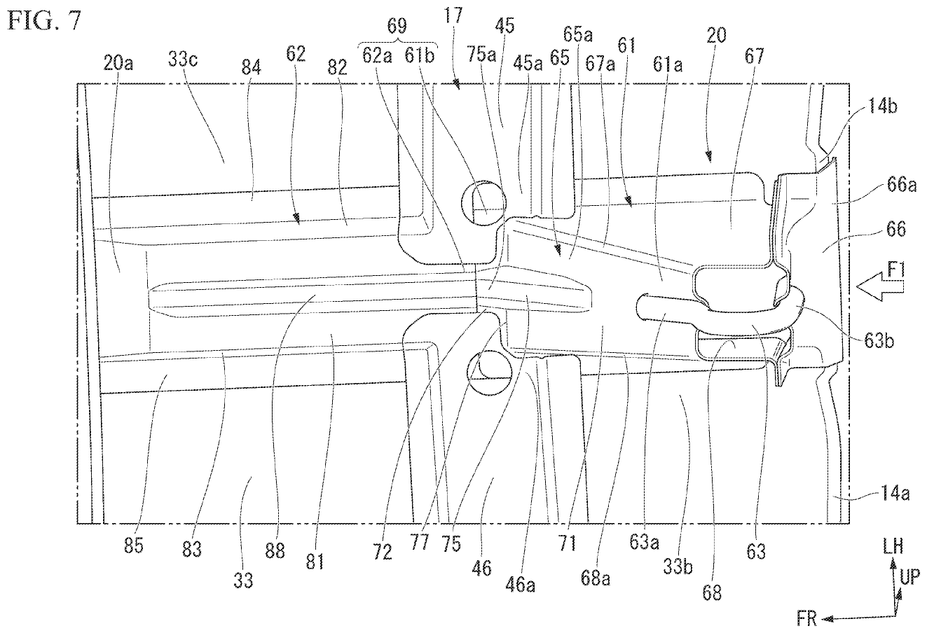

As shown in FIGS. 6 and 7, the jack base 20 includes a base portion 61, a forward extension portion 62, and a towing hook 63. The base portion 61 is formed to extend downward from a rear center portion 33b in the vehicle width direction in a convex shape in a rear end portion of the tire pan bottom portion 33 on a rear side of the vehicle body. The base portion 61 has a front wall portion (forward side) 65, a rear wall portion (rear end portion) 66, a left sidewall portion 67, and a right sidewall portion 68. The left sidewall portion 67 and the right sidewall portion 68 are substantially laterally symmetrical members.

The left sidewall portion 67 and the right sidewall portion 68 are provided in the rear center portion 33b of the tire pan bottom portion 33 with an interval in the vehicle width direction. The left sidewall portion 67 is connected to rear end portions of the rear center portion 33b of the tire pan bottom portion 33 and a left extension flange 84 of the forward extension portion 62 (both of which will be described below). The right sidewall portion 68 is connected to rear end portions of the rear center portion 33b of the tire pan bottom portion 33 and a right extension flange 85 of the forward extension portion 62 (both of which will be described below). In this state, the left sidewall portion 67 and the right sidewall portion 68 extend downward from the rear center portion 33b.

The left sidewall portion 67 has a front side 67a that is inclined with a gradient rising toward a front side of the vehicle body as it goes upward from the lower end portion to the upper end portion. Like the left sidewall portion 67, the right sidewall portion 68 has a front side 68a that is inclined with a gradient rising toward a front side of the vehicle body as it goes upward from the lower end portion to the upper end portion. Accordingly, the left sidewall portion 67 and the right sidewall portion 68 are formed in a triangular shape protruding downward when seen in a side view.

For example, the front wall portion 65 is formed integrally with the left sidewall portion 67 and the right sidewall portion 68 by being folded from the front side 67a of the left sidewall portion 67 and the front side 68a of the right sidewall portion 68. The front wall portion 65 has a front inclined wall portion 71, and a front flange (a front end portion, an upper end portion, a front upper end portion) 72. The front inclined wall portion 71 is inclined with a gradient rising toward a front side of the vehicle body as it goes upward from the lower end portion to the upper end portion by being formed along the front side 67a of the left sidewall portion 67 and the front side 68a of the right sidewall portion 68.

The front flange 72 extends along the tire pan bottom portion 33 from a front upper side of the front inclined wall portion 71 toward a front side of the vehicle body. The front flange 72 is connected to a rear end portion 62a of the forward extension portion 62 (both of which will be described below).

The front wall portion 65 has, for example, a first bead 75 provided on an upper half portion 65a. Here, the upper half portion 65a of the front wall portion 65 is referred to as from a center of the front inclined wall portion 71 to a front side of the front flange 72 in the vehicle body forward/rearward direction. The first bead 75 extends in the vehicle body forward/rearward direction from a center portion of the upper half portion 65a in the vehicle width direction, and bulges downward from the upper half portion 65a at a side in front of the vehicle body. The first bead 75 is formed in a convex shape such that a bead bulging amount is gradually increased as it extends from the lower end portion toward the upper end portion.

As shown in FIGS. 5 and 7, the rear wall portion 66 is connected to a rear end portion of the left sidewall portion 67 and a rear end portion of the right sidewall portion 68. The rear wall portion 66 has an upper end portion 66a that extends upward from the rear end portion of the left sidewall portion 67 and the rear end portion of the right sidewall portion 68 to the rear end portion 14a of the rear floor 14. The upper end portion 66a of the rear wall portion 66 is fixed to a center portion 14b of the rear end portion 14a of the rear floor 14 in the vehicle width direction from behind the vehicle body. The rear wall portion 66 has an upper half portion 66b that is connected to a lower half portion 19a of the reinforcement member 19 from behind the vehicle body.

That is, the base portion 61 is formed in a convex shape (specifically, a triangular shape) protruding downward from the rear center portion 33b of the tire pan bottom portion 33 by the front wall portion 65, the rear wall portion 66, the left sidewall portion 67, and the right sidewall portion 68. In addition, the base portion 61 is a member having high rigidity formed with a closed cross section having a hollow rectangular shape by the front wall portion 65, the rear wall portion 66, the left sidewall portion 67, and the right sidewall portion 68. The towing hook 63 is connected to a lower end portion 61a of the base portion 61.

As shown in FIGS. 6 and 7, the towing hook 63 is formed in substantially a U shape when seen in a side view. The towing hook 63 has a front end portion 63a connected to a lower end portion of the front inclined wall portion 71, and a rear end portion 63b connected to a lower end portion of the rear wall portion 66. Accordingly, the base portion 61 is reinforced by the towing hook 63, and rigidity of the base portion 61 is further increased.

The towing hook 63 is used by hooking a rope to, for example, the towing hook 63 when the vehicle is towed. In addition, the towing hook 63 is used as a jackup point that connects jacks when the vehicle is jacked up.

As shown in FIGS. 2 and 7, the forward extension portion 62 is connected to a front end portion 61b of the base portion 61. That is, the forward extension portion 62 is connected to a center portion 33c of the tire pan bottom portion 33 in the vehicle width direction, and the rear end portion 62a is connected to the front end portion 61b of the base portion 61. Hereinafter, an area in which the front end portion 61b of the base portion 61 and the rear end portion 62a of the forward extension portion 62 are connected is referred to as “a connecting portion 69.”

The forward extension portion 62 continuously extends along the tire pan bottom portion 33 from the front flange 72 of the base portion 61 to a side further forward in the vehicle body from the spare tire fixing portion 34 (i.e., a front rear center portion of the spare tire 41 (see FIG. 3)).

Here, an upper front side corner portion 77 is formed by a crossing portion between the front flange 72 and the front inclined wall portion 71. Accordingly, the forward extension portion 62 extends from the upper front side corner portion 77 parallel to the tire pan bottom portion 33.

The forward extension portion 62 has an extension bottom portion (bottom portion) 81, a left extension sidewall portion 82, a right extension sidewall portion 83, the left extension flange 84, and the right extension flange 85. The forward extension portion 62 is formed with a hat-shaped cross section by the extension bottom portion 81, the left extension sidewall portion 82, the right extension sidewall portion 83, the left extension flange 84, and the right extension flange 85. The left extension flange 84 and the right extension flange 85 of the forward extension portion 62 are connected to the center portion 33c of the tire pan bottom portion 33. Accordingly, the forward extension portion 62 is a member having high rigidity formed with a closed cross section having a hollow rectangular shape together with the tire pan bottom portion 33.

The extension bottom portion 81 is continuously provided on the front flange 72 (a front end portion) of the front wall portion 65. The extension bottom portion 81 has a second bead 88 extending from the front flange 72 toward a front side of the vehicle body.

The second bead 88 extends from a front end portion 75a of the first bead 75 provided on the upper half portion 65a of the front wall portion 65 toward a front side of the vehicle body. The second bead 88 is formed in a concave shape such that an outer surface of the extension bottom portion 81 is recessed upward. The first bead 75 and the second bead 88 extend continuously in the vehicle body forward/rearward direction.

The cross member 17 (i.e., the left cross member 45 and the right cross member 46) are connected to the connecting portion 69 between the extension bottom portion 81 and the base portion 61. For example, the left cross member 45 has an inner end portion 45a connected to a left side area of the connecting portion 69 from below. The left side area of the connecting portion 69 is located at the first bead 75 and the second bead 88 of the connecting portion 69 on the left side in the vehicle width direction.

In addition, the right cross member 46 has an inner end portion 46a that is connected to a right side area of the connecting portion 69 from below. The right side area of the connecting portion 69 is located at the first bead 75 and the second bead 88 of the connecting portion 69 on the right side in the vehicle width direction.

In this way, the inner end portion 45a of the left cross member 45 and the inner end portion 46a of the right cross member 46 (i.e., the cross member 17) are connected to the connecting portion 69. The connecting portion 69 is an area in which the front end portion 61b of the base portion 61 and the rear end portion 62a of the forward extension portion 62 are connected. Accordingly, the inner end portion 45a of the left cross member 45 and the inner end portion 46a of the right cross member 46 (i.e., the cross member 17) are connected to the front end portion 61b of the base portion 61.

Here, the cross member 17 is a rigid member having high strength and rigidity that bridges between the left rear frame 11 and the right rear frame 12 via the connecting portion 69. Accordingly, the connecting portion 69 is reinforced by the cross member 17, and thus, strength and rigidity are secured.

Next, for example, an example in which the rear seat 13 is protected from the spare tire 41 when a load is input to the vehicle body rear structure 10 from behind the vehicle body due to a rear end collision will be described.

As shown in FIGS. 1 and 7, the base portion 61 of the jack base 20 extends in a convex shape protruding downward from the rear center portion 33b of the tire pan bottom portion 33. In addition, the forward extension portion 62 continuously and parallelly extends along the tire pan bottom portion 33 from the front flange 72 of the base portion 61 to a side further forward in the vehicle body from the spare tire fixing portion 34.

In other words, the front end portion of the forward extension portion 62 (i.e., the front end portion 20a of the jack base 20) continuously extends to a side further forward in the vehicle body from the spare tire fixing portion 34.

In this way, the jack base 20 is constituted by the base portion 61 and the forward extension portion 62, and the forward extension portion 62 continuously extends along the tire pan bottom portion 33 to the base portion 61. Accordingly, a relatively large compartment (space) 91 can be secured below the forward extension portion 62 (i.e., the tire pan 15). Accordingly, the room 91 below the tire pan 15 can be effectively utilized, and for example, a degree of layout freedom can be increased when components of the vehicle body are disposed.

Here, when a load F1 due to the rear end collision is input to the rear wall portion 66 of the base portion 61 from behind the vehicle body, for example, the base portion 61 is rotated clockwise about a rear upper portion 61c like an arrow A. Accordingly, the front flange 72 and the upper front side corner portion 77 of the base portion 61 are rotated upward about the rear wall portion 66 like the arrow A.

When the front flange 72 and the upper front side corner portion 77 of the base portion 61 are rotated, the forward extension portion 62 is rotated upward about the rear upper portion 61c like an arrow B together with the front flange 72 and the upper front side corner portion 77.

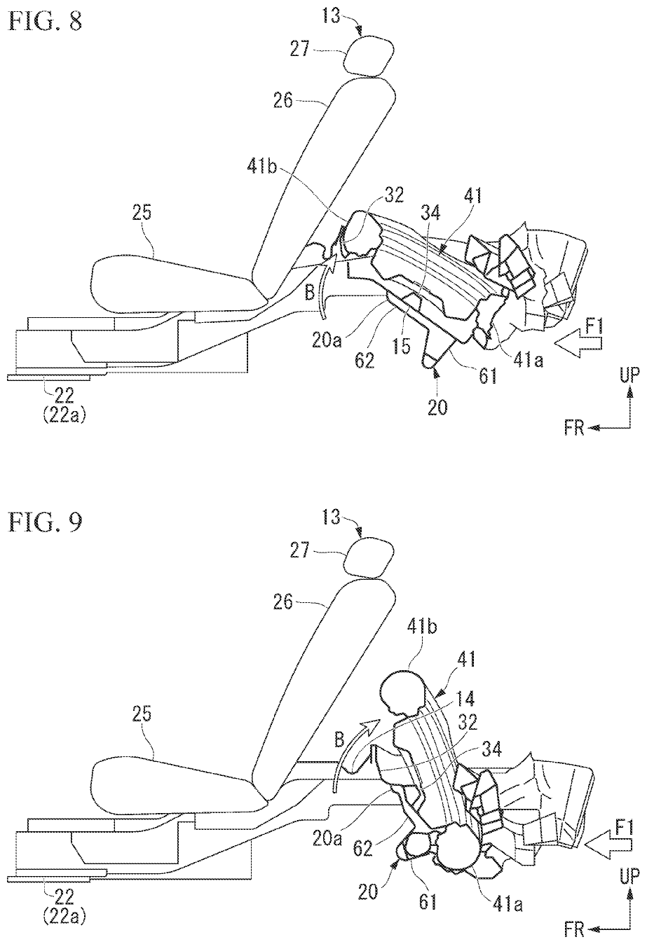

As shown in FIG. 8, the front end portion of the forward extension portion 62 (the front end portion 20a of the jack base 20) continuously extends to the front side of the vehicle body from the spare tire fixing portion 34. Accordingly, when the forward extension portion 62 is rotated upward, the spare tire fixing portion 34 can be lifted upward and toward the rear side of the vehicle body like the arrow B together with the tire pan 15.

Accordingly, the spare tire 41 accommodated in the tire pan 15 is flipped up with a front area 41b being above around a rear end portion 41a and behind the vehicle body like the arrow B. Hereinafter, the front area 41b of the spare tire 41 is also referred to as “an area 41b in front of the spare tire (a forward area).”

As shown in FIG. 9, when the area 41b in front of the spare tire is flipped up above and behind the vehicle body, the area 41b in front of the spare tire can be suppressed from moving toward a front side of the vehicle body. Accordingly, it is possible to prevent the area 41b in front of the spare tire from coming into contact with the seatback 26 of the rear seat 13. Accordingly, it is possible to prevent the spare tire 41 from applying the load F1 to the seatback 26 (i.e., the rear seat 13) due to the load F1 input from behind the vehicle body.

Further, for example, it is possible to prevent the load F1 from being applied to a battery (not shown) or the like provided below the vehicle body (for example, below the rear floor 14 (see also FIG. 1) or the like).

In addition, as shown in FIGS. 1 and 9, the forward extension portion 62 is rotated together with the base portion 61, and the area 41b in front of the spare tire is flipped up above and toward a side behind the vehicle body. Accordingly, the spare tire 41 can be accommodated horizontally in the tire pan 15. Accordingly, it is possible to sufficiently secure the space of the cargo compartment 28 formed above the tire pan 15.

In addition, as shown in FIGS. 1 and 2, the plurality of bead portions 38 are formed on the pan front wall portion 32 as the reinforcement structure 37, and strength and rigidity of the pan front wall portion 32 are improved by the plurality of bead portions 38. Accordingly, for example, when the area 41b in front of the spare tire of the spare tire 41 comes into contact with the pan front wall portion 32 due to the load F1 input from behind the vehicle body, the area 41b in front of the spare tire can be easily flipped up along the pan front wall portion 32. Accordingly, it is possible to more reliably prevent the area 41b in front of the spare tire from coming into contact with the seatback 26 of the rear seat 13.

Here, for example, when the tire pan 15 is shallow (i.e., when the tire pan bottom portion 33 is higher than the ground), the base portion 61 of the jack base 20 needs to be extended downward significantly. For this reason, for example, when the load F1 is applied to the base portion 61 from behind the vehicle body due to the rear end collision, it is conceivable that the base portion 61 will be easier to fold toward the front side of the vehicle body.

Here, the base portion 61 is directed downward to form a convex triangular shape. Further, the front inclined wall portion 71 of the base portion 61 is inclined with a gradient rising toward a front side of the vehicle body as it goes upward from the lower end portion. Accordingly, for example, when the load F1 is applied to the base portion 61 from behind the vehicle body, the front inclined wall portion 71 can prevent the base portion 61 from being folded toward a front side of the vehicle body.

Accordingly, the load F1 applied to the base portion 61 can be transmitted to the tire pan 15 by rotating the forward extension portion 62 (i.e., the jack base 20) together with the base portion 61 by the load F1 applied to the base portion 61. Accordingly, the spare tire fixing portion 34 of the tire pan 15 can be lifted above and toward the side behind the vehicle body, and the area 41b in front of the spare tire can be flipped up and toward the side behind the vehicle body like the arrow B.

In addition, as shown in FIGS. 4 and 7, the front end portion 61b of the base portion 61 is connected to the cross member 17. The cross member 17 is provided on the tire pan bottom portion 33, and bridges between the left rear frame 11 and the right rear frame 12 via the connecting portion 69. That is, the cross member 17 is a rigid member having high strength and rigidity.

Accordingly, by connecting the front end portion 61b of the base portion 61 to the cross member 17, the load F1 input from behind the vehicle body can be transmitted to the cross member 17 from the base portion 61. Accordingly, the base portion 61 can be reliably rotated by the load F1 with no damage to the base portion 61 due to the load F1.

Further, the cross member 17 is bifurcated into the left cross member 45 and the right cross member 46. The inner end portions 45a and 46a of the left cross member 45 and the right cross member 46 are connected to the connecting portion 69 with an interval in the vehicle width direction. Accordingly, for example, when the base portion 61 is rotated by the load F1, the left cross member 45 and the right cross member 46 can be directed upward to be folded in a chevron shape. Accordingly, by rotating the base portion 61, the forward extension portion 62 can be more reliably rotated together with the base portion 61.

In addition, as shown in FIG. 5, the rear wall portion 66 of the base portion 61 is connected to the reinforcement member 19 configured to reinforce the striker fixing portion 18. Accordingly, the rear wall portion 66 of the base portion 61 is reinforced by the reinforcement member 19 of the striker fixing portion 18. Accordingly, strength and rigidity of the rear wall portion 66 of the base portion 61 can be increased. Accordingly, by preventing damage to the base portion 61 due to the load F1 (see FIG. 1) input from behind the vehicle body, the base portion 61 can be reliably rotated by the load F1.

Further, as shown in FIG. 7, the first bead 75 is provided on the front wall portion 65 of the base portion 61, and the second bead 88 is provided on the extension bottom portion 81 of the forward extension portion 62. Further, the first bead 75 and the second bead 88 extend to be continuous in the vehicle body forward/rearward direction. Accordingly, the load F1 input from behind the vehicle body can be transmitted to the forward extension portion 62 from the base portion 61. Accordingly, it is possible to prevent the connecting portion 69 between the base portion 61 and the forward extension portion 62 from being folded. Accordingly, the base portion 61 and the forward extension portion 62 can be reliably rotated.

The technical spirit of the present invention is not limited to the embodiment, and various modifications may be made without departing from the spirit of the present invention.

For example, while the example in which the jack base 20 is formed on the separate member (i.e., a separate body) from the base portion 61 and the forward extension portion 62 has been described in the embodiment, there is no limitation thereto. As another example, for example, the base portion 61 and the forward extension portion 62 of the jack base 20 may be formed integrally with each other.

Further, for example, the front wall portion 65 of the base portion 61 may be inclined upward toward a front side of the vehicle body from the lower end portion 61a of the base portion 61 to the front end portion 20a of the jack base 20. Accordingly, the entire shape of the jack base 20 may be formed in a triangular shape when seen in a side view, and the jack base 20 can be more appropriately rotated by the load F1.

In addition, the components in the embodiment can be appropriately substituted with known components without departing from the spirit of the present invention, and the above-mentioned variants may be appropriately combined.

What is claimed is:

1. A vehicle body rear structure comprising:
a tire pan provided to protrude downward from a floor of a vehicle rear section and including a spare tire fixing portion configured to fix a center portion of a spare tire; and
a jack base provided on the tire pan,
wherein the jack base extends downward from the tire pan on a rear side with respect to a vehicle body, and has a front end portion continuously extending from the spare tire fixing portion to a front side of the vehicle body.

2. The vehicle body rear structure according to claim 1, wherein the jack base comprises:
a base portion extending downward from the tire pan on a rear side of the vehicle body; and
a forward extension portion continuously extending from a front end portion of the base portion to a side further forward in the vehicle body from the spare tire fixing portion.

3. The vehicle body rear structure according to claim 1, wherein the jack base comprises:
a base portion extending downward from the tire pan on a rear side of the vehicle body; and
a forward extension portion continuously extending along the tire pan from a front end portion of the base portion to a side further forward in the vehicle body from the spare tire fixing portion,
wherein the base portion is formed in a convex shape extending downward from a rear end portion of the tire pan, and
the forward extension portion extends parallel to a bottom surface of the tire pan from an upper front side corner portion of the base portion.

4. The vehicle body rear structure according to claim 1, wherein the tire pan has a pan front wall portion extending upward from a front end portion of a bottom surface of the tire pan, and
a reinforcement structure that improves rigidity is provided on the pan front wall portion.

5. The vehicle body rear structure according to claim 4, wherein the reinforcement structure has a bead shape extending in a shape inclined upward from a lower end portion toward an upper end portion of the pan front wall portion and toward a front side of the vehicle body.

6. The vehicle body rear structure according to claim 1, wherein the jack base comprises:
a base portion extending downward from the tire pan on a rear side of the vehicle body; and
a forward extension portion continuously extending along the tire pan from a front end portion of the base portion to a side further forward in the vehicle body from the spare tire fixing portion,
wherein the base portion is formed in a triangular shape protruding downward when seen in a side view, and
the base portion has a front wall portion inclined with a gradient rising upward from a lower end portion toward a front side of the vehicle body.

7. The vehicle body rear structure according to claim 6, wherein the front end portion of the base portion is connected to a cross member which is provided on the tire pan.

8. The vehicle body rear structure according to claim 1, comprising:
a striker fixing portion configured to fix a striker that holds an opening/closing body configured to open and close a cargo compartment formed above the floor at a closed position; and
a reinforcement member configured to reinforce the striker fixing portion,
wherein the jack base has a rear wall portion connected to the reinforcement member.

9. The vehicle body rear structure according to claim 1, wherein the jack base comprises:
a base portion extending downward from the tire pan on a rear side of the vehicle body; and
a forward extension portion continuously extending along the tire pan from a front end portion of the base portion to a side further forward in the vehicle body from the spare tire fixing portion, wherein
the jack base further has:
a first bead provided on a front wall portion of the base portion; and
a second bead provided on a bottom portion of the forward extension portion continuous with the front wall portion,
wherein the first bead and the second bead extend to be continuous in a vehicle body forward/rearward direction.
